(19) United States
(12) Patent Application Publication
(10) Pub. No.: US 2009/0294283 A1
(43) Pub. Date: Dec. 3, 2009

(54) Cell frame for high-pressure water electrolyzer and method for manufacturing the same

(76) Inventors: Timothy J. Norman, Acton, MA (US); Robert W. Milgate, Gloucester, MA (US); Robert Stone, Danvers, MA (US); Edwin W. Schmitt, Arlington, MA (US); Anthony B. LaConti, Lynnfield, MA (US)

Correspondence Address: KRIEGSMAN & KRIEGSMAN, 30 TURNPIKE ROAD, SUITE 9, SOUTHBOROUGH, MA, 01772, US

(21) Appl. No.: 12/387,713

(22) Filed: May 5, 2009

Related U.S. Application Data
(60) Provisional application No. 61/126,493, filed on May 5, 2008.

(51) Int. Cl. C02F 1/461; B23K 20/10; B29C 65/00; C25B 9/00; B23P 11/00

(52) U.S. Cl. 204/279; 228/110.1; 156/60; 29/428

(57) ABSTRACT

Cell frame for high-pressure water electrolyzer and method of manufacturing the same. According to one embodiment, radial openings in a water electrolyzer frame are provided by laminating half-frames, one or both of which contains grooves that may be formed by molding, machining or die-cutting. Another to another embodiment, radial openings are provided by laminating three or more thin frame portions, the center piece of which may include transverse slots that may be made by molding, machining or die-cutting. According to yet another embodiment, two or more frame portions are provided, at least one of which includes a recess for receiving a porous structure. The frames of the present invention can be additionally laminated to the membrane and electrode assembly, as well as the bipolar separator plate in the perimeter or seal area, comprised of the same or similar material as the frame, to form unitized electrolyzer stack subassemblies or full assemblies.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Grant No. DE-FG02-06ER84537 awarded by the Department of Energy.

### CROSS-REFERENCE TO RELATED APPLICATIONS

The present application claims the benefit under 35 U.S.C. 119(e) of U.S. Provisional Patent Application No. 61/126,493, filed May 5, 2008, the disclosure of which is incorporated herein by reference.

### BACKGROUND OF THE INVENTION

The present invention relates generally to water electrolyzers and relates more particularly to a cell frame for a high-pressure (about 200 to 12,000 psi) water electrolyzer and to a method for manufacturing said cell frame.

Water electrolysis is an important process for producing hydrogen, especially at remote sites, for electric generator cooling, materials processing, chemical reactions and laboratory use and analysis. Also, when low-cost power is available from renewable energy sources (e.g., wind, solar), water electrolyzers can cost-effectively and efficiently provide hydrogen, as an alternative to fossil fuels, for stationary and vehicular power applications.

Currently, two different water electrolysis technologies compete in the marketplace. The first and most developed technology is alkaline water electrolysis, in which the stack and cell electrolyte is liquid potassium hydroxide (KOH). The second technology is polymer electrolyte membrane (PEM) water electrolysis technology, which uses a solid proton-conductive membrane as the sole electrolyte in the system. PEM systems have significant advantages over alkaline electrolyzer systems for lightweight or high-pressure breathing or life-support applications, such as on board spacecraft and nuclear submarines. Some of the advantages of a PEM system include (1) superior performance at a given current density, (2) reliability (over 100,000 hours of highly invariant performance), (3) operational safety benefits of deionized-water system over a highly caustic system, and (4) a PEM system can effectively operate at high differential pressures of over 3,000 psi while liquid electrolyte alkaline systems are limited to differential pressures of inches of water.

In a typical PEM water electrolyzer, an anode is positioned along one face of a polymer electrolyte membrane, and a cathode is positioned along the opposite face of the polymer electrolyte membrane. To enhance electrolysis, a catalyst, such as platinum, is typically present both at the interface between the anode and the polymer electrolyte membrane and at the interface between the cathode and the polymer electrolyte membrane. The above-described combination of a polymer electrolyte membrane, an anode, a cathode and associated catalysts is commonly referred to in the art as a membrane electrode assembly.

In use, water is delivered to the anode and an electric potential is applied across the two electrodes, thereby causing the electrolyzed water molecules to be converted into protons, electrons and oxygen atoms. The protons migrate through the polymer electrolyte membrane and are reduced at the cathode to form molecular hydrogen. The oxygen atoms do not traverse the polymer electrolyte membrane and, instead, form molecular oxygen at the anode.

Often, a number of electrolysis cells are assembled together in order to meet hydrogen or oxygen production requirements. One common type of assembly is a stack comprising a plurality of stacked electrolysis cells that are electrically connected in series in a bipolar configuration. In one type of stack, each cell includes, in addition to a membrane electrode assembly of the type described above, a pair of multi-layer metal screens, one of said screens being in contact with the outer face of the anode and the other of said screens being in contact with the outer face of the cathode. The screens are used to conduct electrons to and from the cathode and anode and to form the membrane-supporting fluid cavities within a cell for the flow of water, hydrogen and oxygen. Each cell typically additionally includes a pair of polysulfone cell frames, each cell frame peripherally surrounding a set of screens. The frames are used to peripherally contain the fluids and to conduct the fluids into and out of the screen cavities. Each cell typically further includes a pair of metal foil separators, one of said separators being positioned against the outer face of the anode screen and the other of said separators being positioned against the outer face of the cathode screen. The separators serve to axially contain the fluids on the active areas of the cell assembly. In addition, the separators and screens together serve to conduct electricity from the anode of one cell to the cathode of its adjacent cell. Plastic gaskets may be used to seal the outer faces of the cell frames to the metal separators, the inner faces of the cell frames being sealed to the proton exchange membrane. The cells of the stack are typically compressed between a spring-loaded rigid top end plate and a bottom base plate. Electrically-conductive compression pads may be positioned between adjacent cells in a stack in order to maintain uniform contact pressure over the entire active areas of the electrodes.

Patents and publications relating generally to electrolysis cell stacks include the following, all of which are incorporated herein by reference: U.S. Pat. No. 7,438,985, inventors LaConti et al., issued Oct. 21, 2008; U.S. Pat. No. 7,261,967, inventors LaConti et al., issued Aug. 28, 2007; U.S. Pat. No. 7,229,534, inventors LaConti et al., issued Jun. 12, 2007; U.S. Pat. No. 6,685,821, inventors Kosek et al., issued Feb. 3, 2004; U.S. Pat. No. 6,500,319, inventors LaConti et al., issued Dec. 31, 2002; U.S. Pat. No. 6,057,053, inventor Gibb, issued May 2, 2000; U.S. Pat. No. 5,350,496, inventors Smith et al., issued Sep. 27, 1994; U.S. Pat. No. 5,316,644, inventors Titterington et al., issued May 31, 1994; U.S. Pat. No. 5,009,968, inventors Guthrie et al., issued Apr. 23, 1991; and Coker et al., “Industrial and Government Applications of SPE Fuel Cell and Electrolyzers,” presented at The Case Western Symposium on “Membranes and Ionic and Electronic Conducting Polymer,” May 17-19, 1982 (Cleveland, Ohio).

As noted above, cell frames are often utilized in electrolysis cells to conduct and to contain the cell operating fluids. Such cell frames are typically made of plastics like polysulfones that offer the advantages of chemical inertness and electrical resistance that are desirable and necessary in these cells. Referring now to FIGS. 1 and 2, there are shown top and enlarged fragmentary section views, respectively, of a conventional cell frame for a high-pressure water electrolyzer, said conventional cell frame being represented generally by reference numeral 11.

Frame 11 comprises a unitary annular member 12, member 12 comprising an inner surface 13, an outer surface 15, a top surface 17, and a bottom surface 19. A plurality of transverse openings 21, which may serve as axial ports to fluidly interconnect a number of cell frames, are provided in member 12, each of openings 21 extending transversely from top surface 17 to bottom surface 19. In addition, a plurality of radial passageway sets 23 are provided in member 12, each radial passageway set 23 comprising a plurality of passageways 25 extending radially from inner surface 13 to a common opening 21. Passageways 25, which may be used to deliver operating fluid to and from the active areas of the cell, are preferably small in diameter and yet sufficiently numerous in quantity to provide the necessary fluid flow while, at the same time, providing proper support for heavy sealing loads that might distort or collapse the ceilings and floors of larger openings.

Typically, frames like frame 11 are made by molding the annular body or by machining the annular body from flat stock and, thereafter, drilling the radial passageways into the annular body after the rest of the frame has been completed. As can be appreciated, the drilling of the radial passageways can be very slow and very expensive and can result in many rejections due to broken drills and wandering passageways. While it is possible to incorporate the passageways into an injection molding, this significantly complicates the design and cost of the mold and may be limited in minimizing the spacing between passageways; furthermore, in many applications, the number of frames to be used does not justify the considerable expense of an injection mold. Also, it becomes extremely difficult to fabricate thin frames (<0.060 in. thick) and effectively drill radial passageways into the frames.

### SUMMARY OF THE INVENTION

It is an object of the present invention to provide a novel cell frame for a high-pressure water electrolyzer.

It is another object of the present invention to provide a cell frame as described above that addresses at least some of the disadvantages associated with conventional cell frames.

It is still another object of the present invention to provide a method for manufacturing a cell frame as described above.

Therefore, according to one aspect of the invention, there is provided a method of manufacturing a cell frame suitable for use in an electrochemical cell, said method comprising the steps of (a) providing a first frame portion, said first frame portion comprising an inner surface, an outer surface, a top surface, a bottom surface, and an axial port; (b) providing a second frame portion, said second frame portion comprising an inner surface, an outer surface, a top surface, a bottom surface, and an axial port; (c) wherein at least one of said first frame portion and said second frame portion includes a radial groove extending from its inner surface to its axial port; and (d) then, with their respective axial ports aligned, joining said first and second frame portions to one another so as to jointly define a radial passageway therebetween using said radial groove.

According to another aspect, there is provided a method of manufacturing a cell frame suitable for use in an electrochemical cell, said method comprising the steps of (a) providing a first frame portion, said first frame portion comprising an inner surface, an outer surface, a top surface, a bottom surface, and an axial port; (b) providing a second frame portion, said second frame portion comprising an inner surface, an outer surface, a top surface, a bottom surface, and an axial port; (c) providing a third frame portion, said third frame portion being positioned between said first frame portion and said second frame portion, said third frame portion comprising at least one of a radial slot and a radial passageway; and (d) then, with the axial ports of said first and second frame portions aligned, joining together said first, second and third frame portions.

According to still another aspect, there is provided a method of manufacturing a cell frame suitable for use in an electrochemical cell, said method comprising the steps of (a) providing a first frame portion, said first frame portion comprising an inner surface, an outer surface, a top surface, a bottom surface, and an axial port; (b) providing a second frame portion, said second frame portion comprising an inner surface, an outer surface, a top surface, a bottom surface, and an axial port; (c) providing a third frame portion, said third frame portion being positioned between said first frame portion and said second frame portion, said third frame portion comprising a porous member; and (d) then, with the axial ports of said first and second frame portions aligned, joining together said first, second and third frame portions.

The present invention is also directed to cell frames made by the aforementioned methods.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a top view of a conventional cell frame for a high-pressure water electrolyzer;

FIG. 2 is an enlarged fragmentary section view, taken along line 1-1, of the conventional cell frame of FIG. 1;

FIG. 3 is a top view of a first embodiment of a cell frame for a high-pressure water electrolyzer, the cell frame being constructed according to the teachings of the present invention;

FIG. 4 is a bottom view of the cell frame of FIG. 3;

FIG. 5 is an enlarged exploded fragmentary side view of the cell frame of FIG. 3;

FIG. 6 is a bottom view of the top half-frame portion shown in FIG. 5;

FIG. 7 is a top view of the bottom half-frame portion shown in FIG. 5;

FIG. 8 is a top view of a second embodiment of a cell frame for a high-pressure water electrolyzer, the cell frame being constructed according to the teachings of the present invention;

FIG. 9 is an enlarged exploded fragmentary side view of the cell frame of FIG. 8;

FIG. 10 is a top view of a third embodiment of a cell frame for a high-pressure water electrolyzer, the cell frame being constructed according to the teachings of the present invention;

FIG. 11 is an enlarged exploded fragmentary side view of the cell frame of FIG. 10;

FIG. 12 is an exploded fragmentary side view of a fourth embodiment of a cell frame for a high-pressure water electrolyzer, the cell frame being constructed according to the teachings of the present invention;

FIG. 13 is a bottom view of the top frame portion shown in FIG. 12;

FIG. 14 is a top view of the bottom frame portion shown in FIG. 12;

FIG. 15 is an enlarged fragmentary top view of the intermediate frame portion shown in FIG. 12;

FIG. 16 is a top view of a fifth embodiment of a cell frame for a high-pressure water electrolyzer, the cell frame being constructed according to the teachings of the present invention;

FIG. 17 is an enlarged exploded fragmentary side view of the cell frame of FIG. 16;

FIG. 18 is a perspective view of the optical mask referenced in Example 1; and

FIG. 19 is a graphic representation of the data discussed in Example 1.

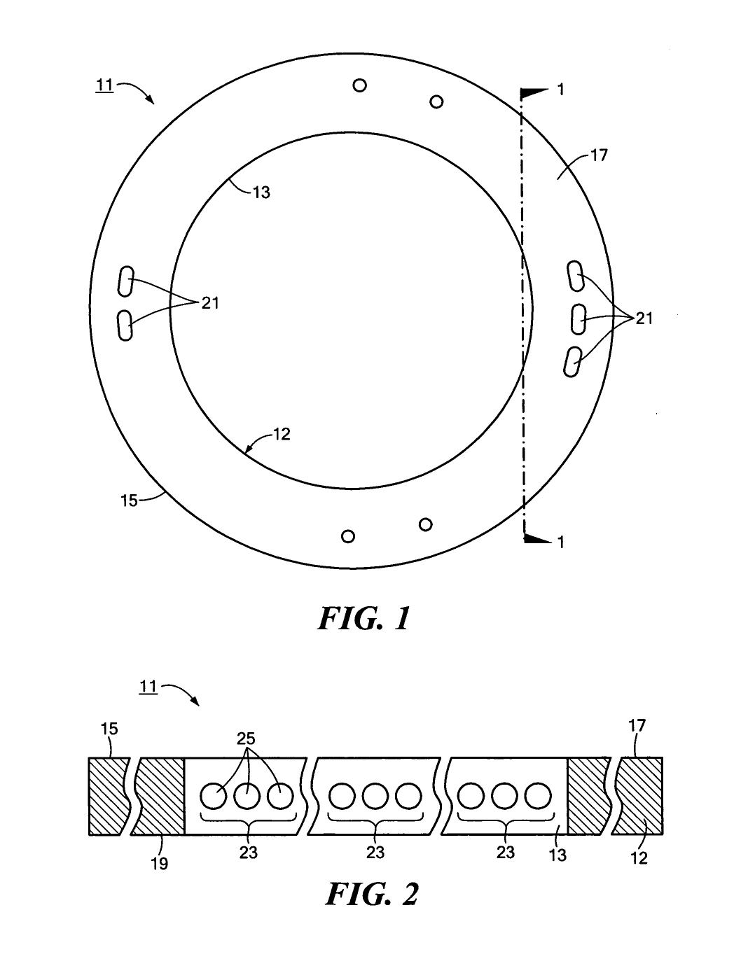

### DETAILED DESCRIPTION OF PREFERRED EMBODIMENTS

One of the objectives of the present invention is to provide an innovative process to fabricate low-cost cell frames for a PEM or alkaline electrolyzer and fuel cell that can be easily laminated and integrated (i.e. joined or welded) with other cell components, such as the MEA and/or bipolar separator to form a unitized subassembly or full assembly.

According to one aspect, this invention provides for incorporating radial passageways into a water electrolyzer plastic thin-film (less than 0.060 in. thick) frame, especially a high-pressure (200 to 12,000 psi) electrolyzer, by laminating the frames of two pieces, one or both of which have grooves molded or machined into one face of the half frame and then joining the two half frames by laser welding, ultrasonic, ultra-violet, infra-red, microwave or radiofrequency radiation, thermal/pressure bonding, solvent cementing, adhesive bonding or other joining methods resulting in a one-piece unitized frame incorporating the radial passageways. The grooves can be molded into the half-frames by injection or compression molding or by thermal forming utilizing significantly simpler and cheaper molds than would be required to mold the passageways in a one-piece frame. Similarly, it can be significantly easier, faster and cheaper to cut open slots or half-passageways in half-frames than to drill passageways in one-piece frames.

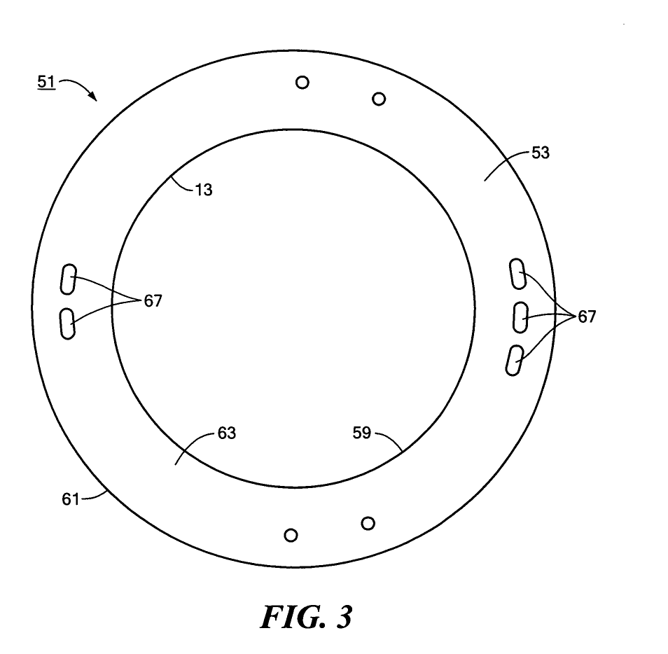

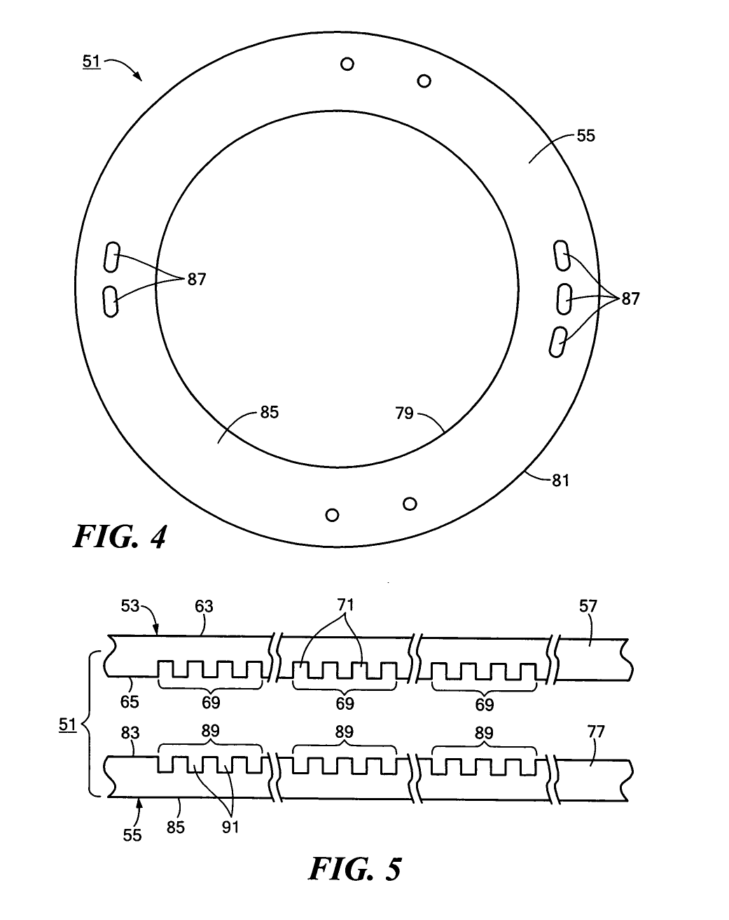

Referring now to FIGS. 3 through 5, there are shown top, bottom, and exploded fragmentary side views, respectively, of a first embodiment of a cell frame for a high-pressure water electrolyzer, the cell frame being constructed according to the teachings of the present invention and being represented generally by reference numeral 51. (Certain aspects of cell frame 51 that are not important to the present invention are not shown or discussed herein.)

Cell frame 51 may comprise a top half-frame portion 53 and a bottom half-frame portion 55. Top half-frame portion 53 and bottom half-frame portion 55 may have substantially matching overall dimensions and may be joined to one another by suitable means. (For example, where top half-frame portion 53 and bottom half-frame portion 55 are both made of polysulfone, top half-frame portion 53 and bottom half-frame portion 55 may be joined together by laser welding.)

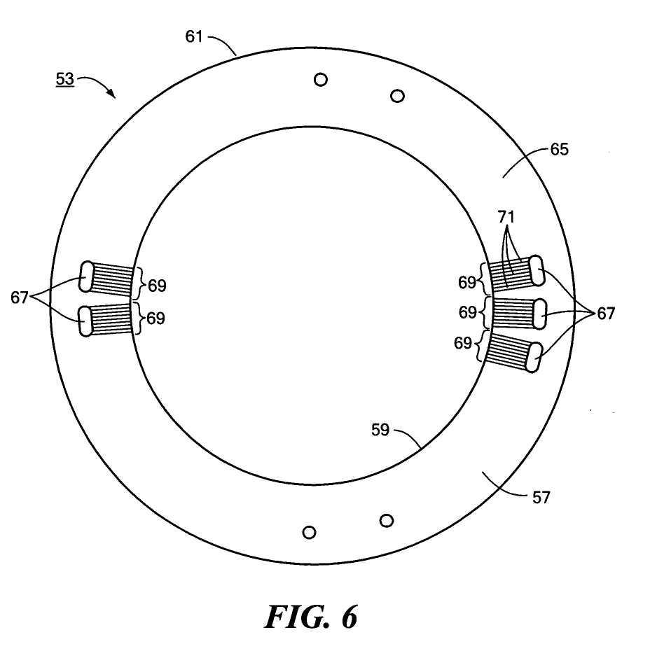

Top half-frame portion 53 (shown separately in FIG. 6), which may be molded and/or machined from a suitable material, may comprise a unitary annular member 57. (For purposes of the present specification and claims, the term “annular” is intended not only to encompass structures having a circular profile but also to encompass bordered structures having other geometric profiles, such as, but not limited to, triangular, rectangular, pentagonal, etc.) Member 57 may comprise an inner surface 59, an outer surface 61, a top surface 63, and a bottom surface 65. A plurality of transverse openings 67, which may serve as axial ports, may be provided in member 57. Each of openings 67 may extend transversely from top surface 63 to bottom surface 65. In addition, a plurality of radial groove sets 69 may be provided in member 57. Each radial groove set 69 may comprise a plurality of grooves or slots 71 extending radially along bottom surface 65 from inner surface 59 to a common opening 67. Grooves 71 may have a square profile, as in the embodiment shown, or may have a rounded profile or other suitable profile.

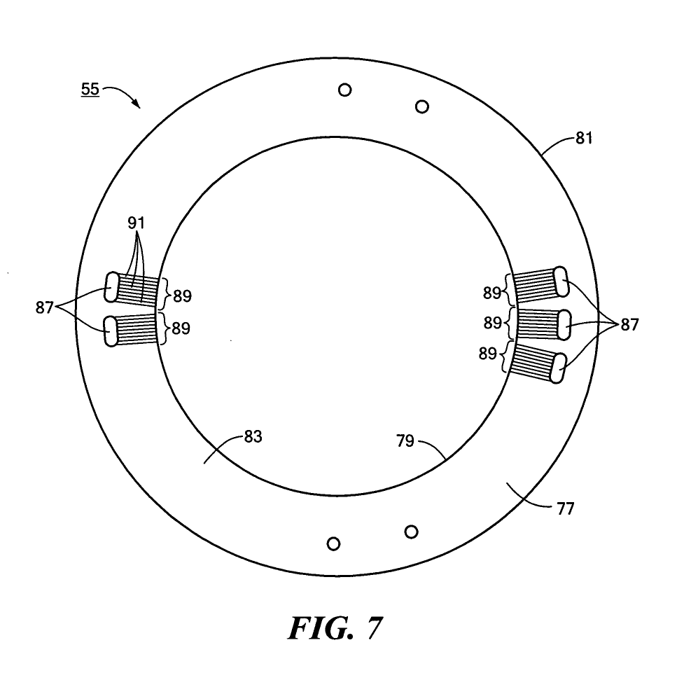

Bottom half-frame portion 55 (shown separately in FIG. 7), which may be molded and/or machined from a suitable material, may comprise a unitary annular member 77. Member 77 may comprise an inner surface 79, an outer surface 81, a top surface 83, and a bottom surface 85. A plurality of transverse openings 87, which may serve as axial ports, may be provided in member 77. Each of openings 87 may extend transversely from top surface 83 to bottom surface 85. Preferably, openings 87 are appropriately dimensioned and positioned to permit their alignment with openings 67 of top half-frame portion 53. In addition, a plurality of radial groove sets 89 may be provided in member 77. Each radial groove set 89 may comprise a plurality of grooves 91 extending radially along top surface 83 from inner surface 79 to a common opening 87. Grooves 91 may have a square profile, as in the embodiment shown, or may have a rounded profile or other suitable profile. Preferably, grooves 91 are appropriately dimensioned and positioned to permit their alignment with grooves 71 on top half-frame portion 53 so that grooves 71 and 91 jointly define radial passageways or openings extending from the inner periphery of cell frame 51 to their corresponding axial ports. The dimensions and quantities of such radial passageways may be similar to those of frame 11 but need not be. If desired, the radial passageways may have a diameter of 0.03 inch or less.

Top half-frame portion 53 and bottom half-frame portion 55 may be the same or different in material composition and may be made from one or more suitable plastics, metals, ceramics, or other high-strength thin film material. Examples of suitable plastics include polysulfone, polyethersulfone, polyphenylene, polyphenylene sulfide, polyphenylene oxide, polybenzimidazole and other liquid-crystal polymers. Examples of suitable metals include titanium, zirconium, and niobium.

Preferably, the combined thickness of top half-frame portion 53 and bottom half-frame portion 55 is less than about 0.060 inch.

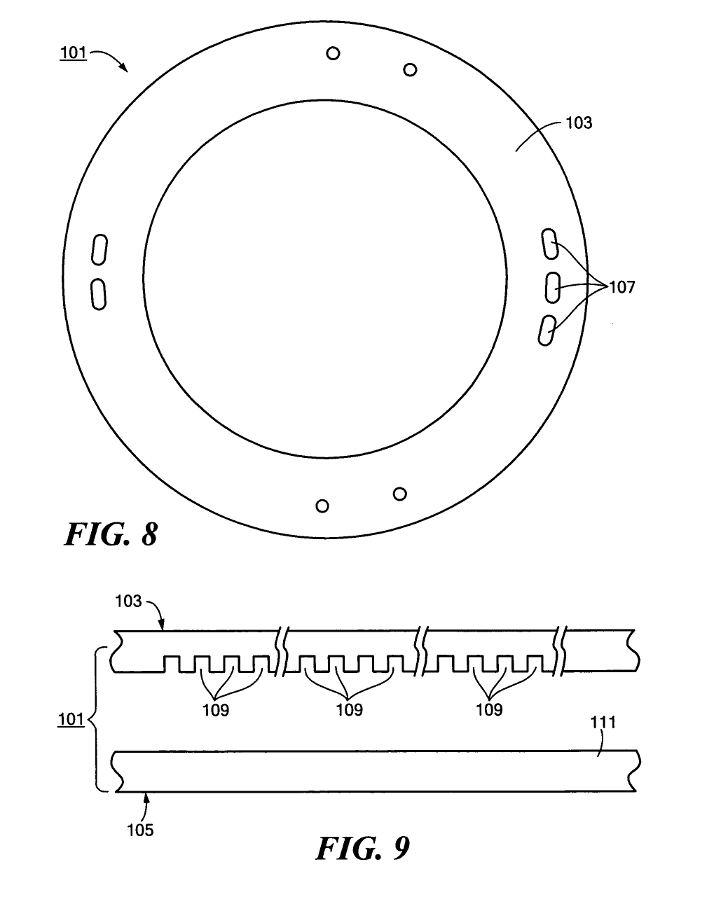

Referring now to FIGS. 8 and 9, there are shown top and enlarged exploded fragmentary side views, respectively, of a second embodiment of a cell frame for a high-pressure water electrolyzer, the cell frame being constructed according to the teachings of the present invention and being represented generally by reference numeral 101. (Certain aspects of cell frame 101 that are not important to the present invention are not shown or discussed herein.)

Cell frame 101, which may be similar in many respects to cell frame 51, may comprise a top half-frame portion 103 and a bottom half-frame portion 105. Top half-frame portion 103 and bottom half-frame portion 105 may have substantially matching overall dimensions and may be joined to one another by suitable means. Top half-frame portion 103, which may be identical to top half-frame portion 53 of frame 51, may be shaped to include transverse openings 107 and radial grooves 109 similar to openings 67 and grooves 71, respectively, of top half-frame portion 53. Grooves 109 may have a square profile, as in the embodiment shown, or may have a rounded profile or other suitable profile. Bottom half-frame portion 105 may be similar in most respects to bottom half-frame portion 55, the principal difference between the respective bottom half-frame portions being that bottom half-frame portion 105 has a top surface 111 that does not include any radial grooves. As can be appreciated, when top half-frame portion 103 and bottom half-frame portion 105 are joined, radial grooves 109 of top half-frame portion 103 and top surface 111 of bottom half-frame portion 105 collectively form a plurality of radial passageways.

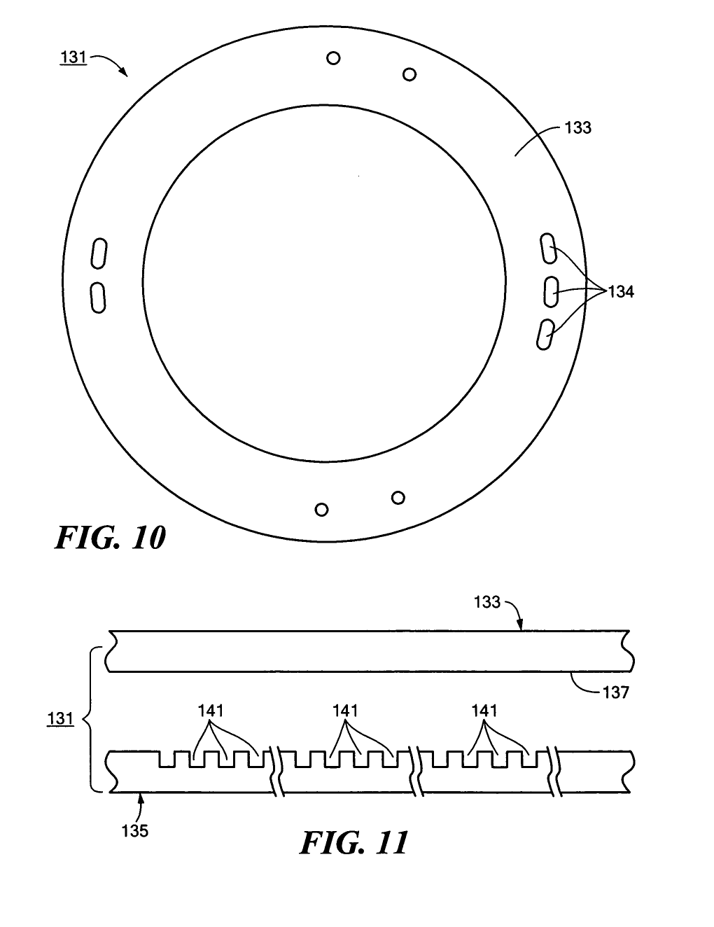

Referring now to FIGS. 10 and 11, there are shown top and enlarged exploded fragmentary side views, respectively, of a third embodiment of a cell frame for a high-pressure water electrolyzer, the cell frame being constructed according to the teachings of the present invention and being represented generally by reference numeral 131. (Certain aspects of cell frame 131 that are not important to the present invention are not shown or discussed herein.)

Cell frame 131, which may be similar in many respects to cell frame 51, may comprise a top half-frame portion 133 and a bottom half-frame portion 135. Top half-frame portion 133 and bottom half-frame portion 135 may have substantially matching overall dimensions and may be joined to one another by suitable means. Top half-frame portion 133, which may be similar in most respects to top half-frame portion 53, may include transverse openings 134 corresponding to transverse openings 67 of top half-frame portion 53. The principal difference between the respective top half-frame portions may be that top half-frame portion 133 has a bottom surface 137 that does not include any radial grooves. Bottom half-frame portion 135, which may be identical to bottom half-frame portion 55 of frame 51, may be shaped to include transverse openings (not shown) and radial grooves 141 similar to openings 87 and grooves 91, respectively, of bottom half-frame portion 55. Grooves 141 may have a square profile, as in the embodiment shown, or may have a rounded profile or other suitable profile. As can be appreciated, when top half-frame portion 133 and bottom half-frame portion 135 are joined, radial grooves 141 of bottom half-frame portion 135 and bottom surface 137 of top half-frame portion 133 collectively form a plurality of radial passageways.

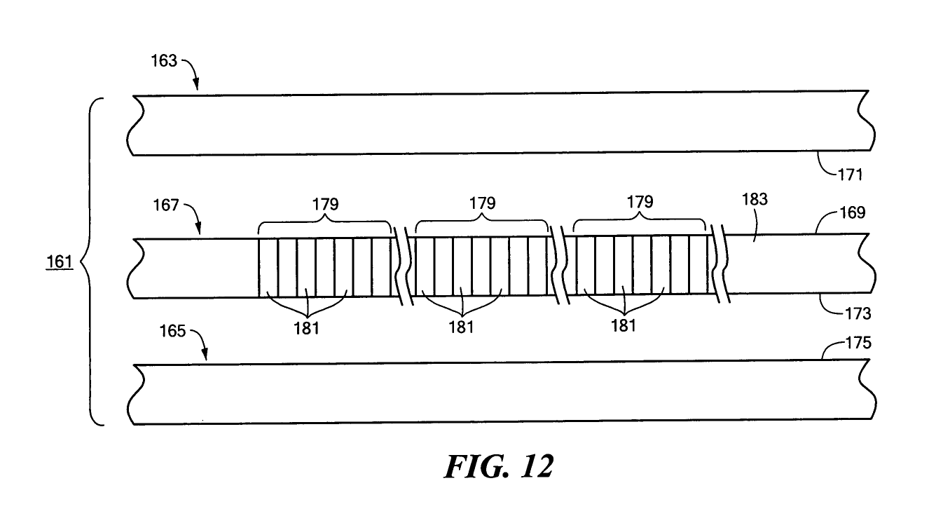

Referring now to FIG. 12, there is shown an exploded fragmentary side view of a fourth embodiment of a cell frame for a high-pressure water electrolyzer, the cell frame being constructed according to the teachings of the present invention and being represented generally by reference numeral 161. (Certain aspects of cell frame 161 that are not important to the present invention are not shown or discussed herein.)

Cell frame 161 may comprise a top frame portion 163, a bottom frame portion 165, and an intermediate frame portion 167, intermediate frame portion 167 being positioned between top frame portion 163 and bottom frame portion 165. Top frame portion 163, bottom frame portion 165, and intermediate frame portion 167 may have substantially matching overall dimensions. The top surface 169 of intermediate frame portion 167 may be joined to the bottom surface 171 of top frame portion 163 by suitable means, and the bottom surface 173 of intermediate frame portion 167 may be joined to the top surface 175 of bottom frame portion 165 by suitable means. For example, where top frame portion 163, bottom frame portion 165 and intermediate frame portion 167 are each made of polysulfone, laser welding may be used to join the various portions together.

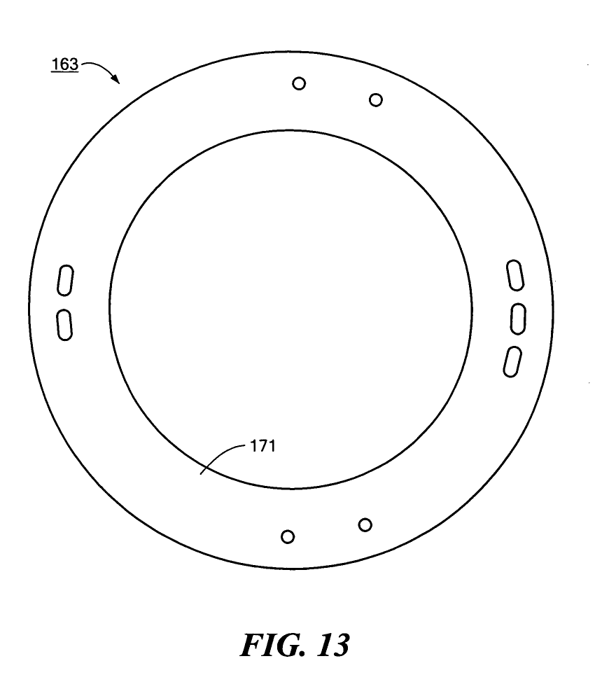

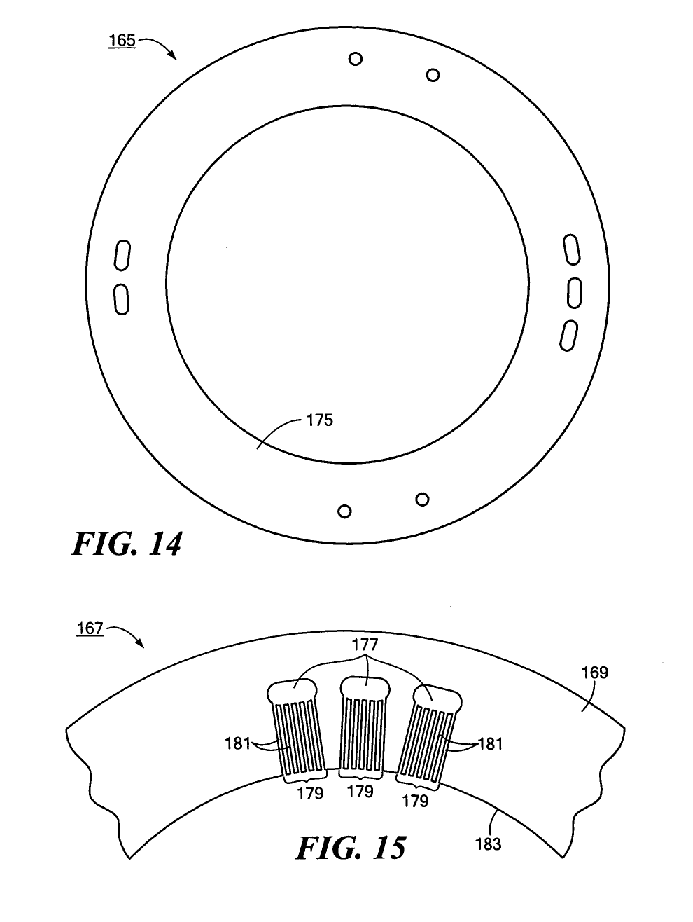

Top frame portion 163 (shown separately in FIG. 13) may be substantially identical to top half-frame portion 133 of frame 131, and bottom frame portion 165 (shown separately in FIG. 14) may be substantially identical to bottom half-frame portion 105 of frame 101. Intermediate frame portion 167 (shown separately in FIG. 15) may be shaped to include a plurality of transverse openings 177, which may be aligned with similar openings in top frame portion 163 and bottom frame portion 165 for use as axial ports. In addition, intermediate frame portion 167 may be shaped to include a plurality of radial slot sets 179. Each radial slot set 179 may comprise a plurality of slots 181 extending transversely from top surface 169 to bottom surface 173 and radially from an inner surface 183 to a common opening 177. Slots 181 may have a square profile, as in the embodiment shown, or may have a rounded profile or other suitable profile. As can be appreciated, when assembled, bottom surface 171 of top frame portion 163, top surface of bottom frame portion 165, and each slot 181 may collectively form a radial passageway.

Preferably, in manufacturing cell frame 161, transverse openings 177 are not formed in intermediate frame portion 167 until after top frame portion 163 and bottom frame portion 165 have been joined to intermediate frame portion 167. In this manner, a web of material would be provided to hold the “fingers” of material between slots 181 in place during the lamination process. This web of material could then be removed by a die-cutting or machining step after the frame portions have been bonded together. This concept permits the forming of slots 181 in intermediate frame portion 167 by die-cutting, which can be significantly cheaper in both tooling and labor than other methods.

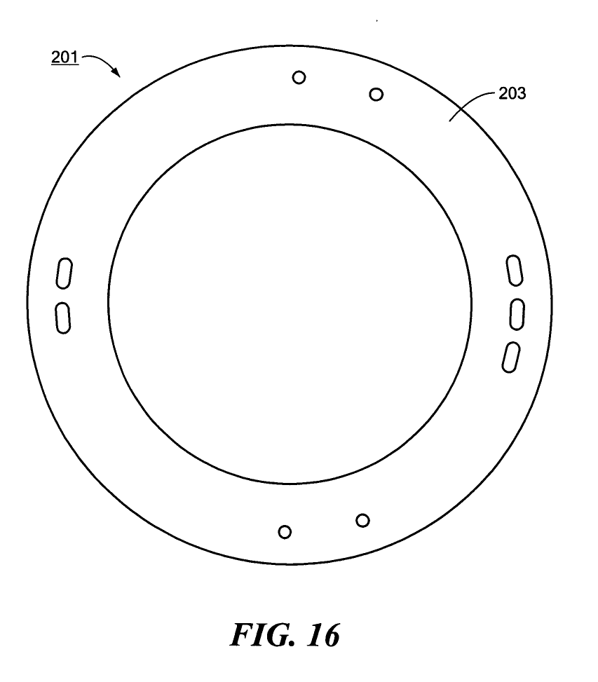

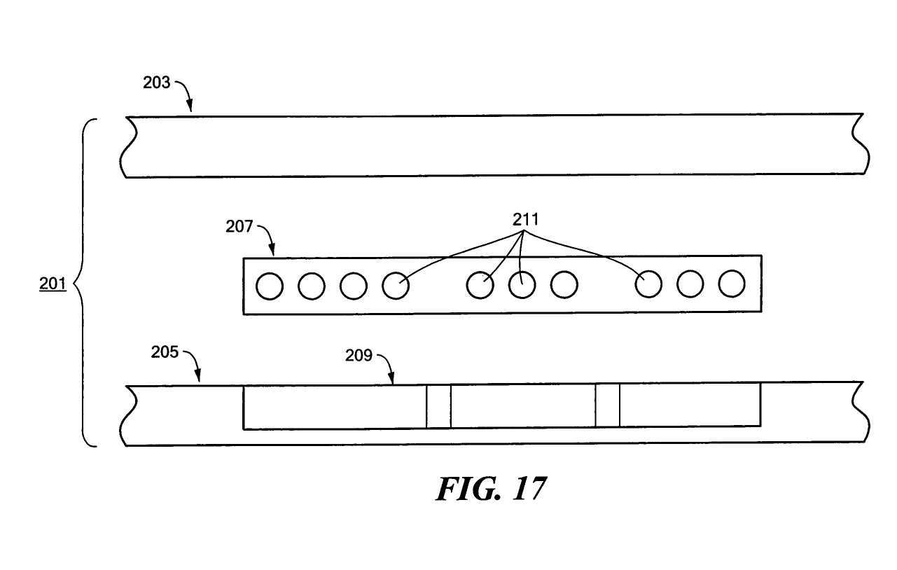

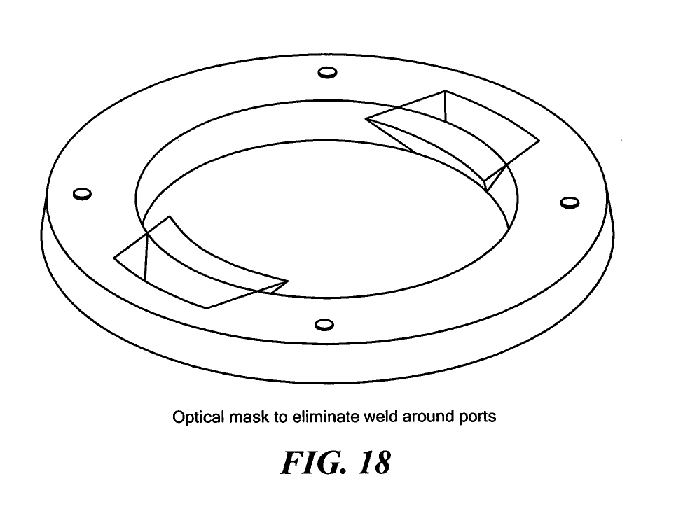

Referring now to FIGS. 16 and 17, there are shown top and enlarged exploded fragmentary side views, respectively, of a fifth embodiment of a cell frame for a high-pressure water electrolyzer, the cell frame being constructed according to the teachings of the present invention and being represented generally by reference numeral 201. (Certain aspects of cell frame 201 that are not important to the present invention are not shown or discussed herein.)

Cell frame 201 may comprise a top frame portion 203, a bottom frame portion 205, and an insert 207. Top frame portion 203 may be substantially identical to top frame portion 163 of frame 161. Bottom frame portion 205 may be similar to bottom half-frame portion 165 of frame 161, except that bottom frame portion 205 may include a recess 209 in the area corresponding to the area in which radial grooves sets 89 may be disposed in bottom half-frame portion 55. Insert 207, which may be made of a more rigid material than that used to form top frame portion 203 and bottom frame portion 205 (to maintain its structural integrity), may be dimensioned to match the dimensions of recess 209 and may be fixedly mounted therewithin by a suitable bonding process, such as laser or thermal/pressure welding. As shown in the present embodiment, insert 207 may be provided with a plurality of radial passageways or openings 211. Alternatively, the top surface of insert 207 may be provided with a plurality of radial grooves that cooperate with the bottom surface of top frame portion 203 to define radial passageways. Alternatively, insert 207 may be made of a porous material, such as a sinter, a mesh, a foam, or the like.

It should be noted that the design of the plastic half-frames or thin-film frame portions described above may incorporate pins or tabs or other features to properly align the frames during the bonding process so that the half openings are properly aligned in the bonded finished frame. A bonding fixture may be utilized to insure proper alignment and removal. TEFLON®-coated pins may be used in the openings to prevent plugging of the openings by flowing plastic or adhesive and/or to maintain shape during the bonding process.

It should be noted that the laminated frame of the present invention, with its radial openings, either after or during its fabrication, can be further laminated (or welded) to an MEA containing the same or similar (laminate-compatible) plastic material on its non-porous solid perimeter (non-electrochemically active area). This will form a laminated unitized frame/MEA structure.

After or during its fabrication, the unitized frame/MEA structure can be additionally laminated to a composite (i.e. plastic/carbon) bipolar plate (separator) containing some of the same plastic material on its outer perimeter. This would form a unitized cell subassembly comprised of laminated, unitized frame/MEA/bipolar plate, containing the enclosed electrically conductive current collectors and fluid-distribution components. The unitized subassembly containing the molded frame and other cell components, during or after fabrication, can be further laminated to other similar subassemblies to form a unitized, laminated partial or full stack assembly. Some of the preferred plastics for use as the frame material, MEA substrate and bipolar plate include polysulfone, polyethersulfone, polyphenylene, polyphenylene sulfide, polyphenylene oxide, polybenzimidazole and other liquid-crystal polymers.

One or more of the individual plastic components utilized in the laminating process may contain fillers such as carbon powder, fibers, dyes or other promoters to enhance radiation or thermal absorption (i.e., ultrasonic, laser) to control the laminating processes and increase the bond strength between the plastic members.

The examples below are illustrative only and do not limit the present invention.

### EXAMPLE 1

### Laminated and Integrated Cell Frame for High Pressure Water Electrolysis Operation:

The first step in fabricating the laminated and integrated cell frame for high pressure water electrolyzer operation was the development of an embossing mold capable of manufacturing the half-frame suitable for joining. This mold required several iterations to achieve success. First, we had to design slots (channels) that permitted the removal of the finished piece without ruining the part or the mold. This required the inclusion of appropriate draft angles in the channel region. The second iteration required a more careful angular alignment between the upper and lower halves of the embossing mold. Our first parts were not usable because the channels lined up below the sealing ribs and the welded part would have not sealed. We improved the mold design to properly locate the channels relative to the sealing ribs and allow easy part removal.

We then used the embossing mold to produce half-frames from a variety of sheet stock. Half-frame parts were successfully formed from 0.032″, 0.020″, 0.015″ and 0.010″ thick polysulfone sheet. Reducing frame thickness is a key part of our low-cost-design approach. The thinner frame requires less material for the anode and cathode compartments. As long as fluid flow considerations are properly accounted for, the thinner cell should result in a lower cost part.

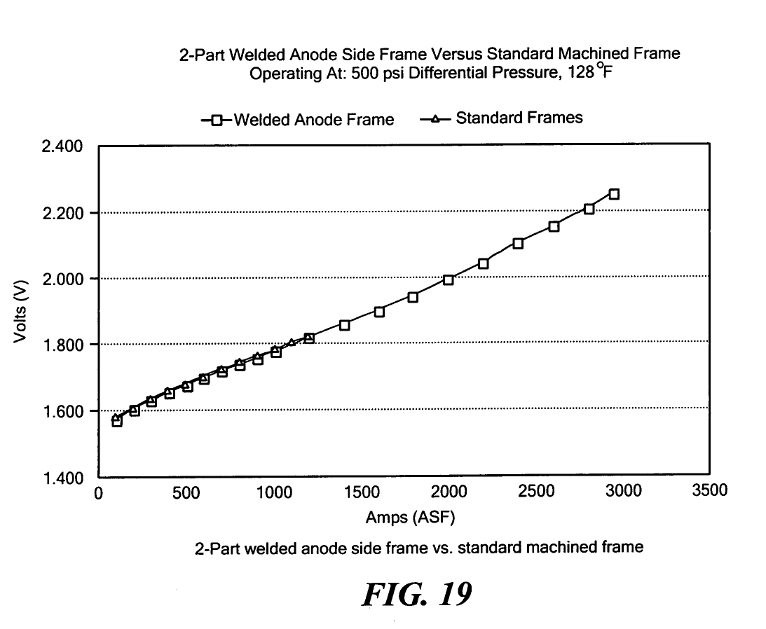

Experimentally, it was determined that, to laser laminate the two half-frames, it was necessary that at least one of the parts must absorb the infra-red (IR) radiation. (Typically, natural (no fillers or dyes) polysulfone does not readily absorb IR radiation.) The approach was to purchase carbon-filled polysulfone (carbon is a well-known IR absorber). While sheet stock is not available with carbon black-filled polysulfone, we were able to produce usable half-frames down to 0.015″ thick made from natural and carbon-filled pellets in the embossing mold. We worked with Branson, Inc. to manufacture a laser optical die to concentrate the laser energy at the appropriate part of the assembly (see FIG. 19, which shows an optical mask to eliminate a weld around ports). We then traveled to the Branson facility in Honeoye Falls, N.Y. in order to investigate the laser weld process parameters and the adjustments for optimal parts. These were as follows: the contact force between the parts to be welded; the laser travel speed; and the thickness and location of silicone contact pressure pads (see Table 1). Our first parts used laser energy directed throughout the seal area including the ported region. On inspection, these parts appeared to produce a good quality weld, but the plastic melt in the ported region flowed into the ports, occluding them, and causing a slight collapse of the material thickness so the sealing ridges were compromised. We then used the laser die to eliminate the weld directly over the ported region. These parts were again welded with good quality as judged by test engineers. Unlike the fully welded parts, these did not occlude the flow path or collapse in the ported region, so we made several copies of this part with several different energy intensities. Based on sections taken from these tests, we optimized the weld speed to 5 inches per second transit speed. A finished laminated frame (final thickness of approximately 0.06″) was used on the anode (low pressure) side of a water electrolysis cell operated at a differential pressure of 500 psi. Performance was identical to the cell assembled with a standard frame (see FIG. 20).

TABLE 1
Frame Welding Parameter Log

| | | SILICONE | | | |
|---|---|---|---|---|---|
| | SPEED | T = Top, | | | |
| RUN | (in/min) | B = Bottom | PRESSURE | | COMMENTS |
| 1 | 300 | (0.060) | 50 | psi | Partially Welded |
| | | T & B | | | |
| 2 | 250 | T & B | 50 | psi | Partially Welded |
| 3 | 250 | T & B | 80 | psi | Slightly Wider Welded |
| 4 | 220 | T & B | 80 | psi | |
| 5 | 250 | B | 50 | psi | (3 Ports) Weld Visually Better |
| 6 | 300 | B | 50 | psi | (2 Ports) Weld Visually Better |
| 7 | 250 | 0.020 T | 50 | psi | Only Welding Around Ports |
| | | 0.060 B | | | |
| 8 | 250 | 0.020 T | 80 | psi | Improved welding All Around |
| | | 0.060 B | | | |
| 9 | 300 | 0.020 T | 80 | psi | |
| | | 0.060 B | | | |
| 10 | 300 | 0.020 T | 100 | psi | |
| | | 0.060 B | | | |
| 11 | 300 | 0.020 T | 100 | psi | Part w/Porous Metal Inserts |
| | | 0.060 B | | | @ Port Area |
| 12 | 300 | 0.020 T | 100 | psi | Part w/Porous Metal Inserts |
| | | 0.060 B | | | @ Port Area |
| 13 | 300 | 0.020 T | 100 | psi | Cleaned Both Parts w/Alcohol |
| | | 0.060 B | | | No Metal Inserts |
| 14 | 300 | 0.020 T | 100 | psi | w/Metal Inserts, |
| | | 0.060 B | | | Cleaned w/Alcohol & Wipes |
| 15 | 300 | 0.020 T | 100 | psi | No Metal Inserts, Cleaned Weld |
| | | 0.060 B | | | Surfaces w/Scotch Brite & Alcohol |
| 16 | 300 | 0.020 T | 100 | psi | w/No Metal Inserts, |
| | | 0.060 B | | | Cleaned w/Alcohol & Wipes |
| 17 | 300 | 0.060 B | 100 | psi | w/Wave Guide |
| 18 | 270 | 0.060 B | 100 | psi | w/Wave Guide |
| 19 | 270 | 0.060 B | 100 | psi | w/Wave Guide & Membrane |
| | | | | | No Weld Under Membrane |
| 20 | 130 | 0.060 B | 100 | psi | No Weld Under Membrane |

### EXAMPLE 2

### Unitized-Frame/Composite Ionomer Membrane or MEA:

The fabrication of a thin film ionomer membrane (or MEA) to frame-laminating process was performed. Recently, the present assigned has developed a novel proton exchange membrane ionomer structure that has demonstrated excellent mechanical properties. This dimensionally stable membrane (DSM™) comprises a thin plastic substrate (i.e., polysulfone) having millions of patterned (i.e., laser drilled) holes of 10 to 30 microns diameter that are imbibed or filled with an ionomer (i.e., NAFION perfluorocarbon sulfonic acid) to form a mechanically stable PEM thin film ionomer membrane. The edges of this composite membrane contain only the solid (no holes) plastic substrates while the “precursor electrochemically active” center area comprises the ionomer-filled holes. One of the important features of this composite DSM film is that the substrate can be made of the same mechanically stable thermoplastic (i.e., polysulfone) as the frame material.

The present inventors demonstrated that the extremely thin (0.008 to 0.025″) composite DSM film can produce a robust laminate using a controlled local thermal weld between the DSM film and frame. The thermal weld process was performed with a conventional bag heat sealer at temperatures just above the melting point of polysulfone (i.e., approximately 350° C.).

It was also shown that it is possible to capture metallic structures (i.e., current collectors, fluid distributors, pressure compliance components) within the welded frame part.

This unitized frame/composite ionomer film laminating structure (i.e., using polysulfone or polyphenylene sulfide as the thermoplastic) process is applicable to PEM or alkaline electrolyzers and can be extended to the bipolar current collectors comprised of the same or similar plastic material.

It is to be understood that the principles of the present invention are not limited to cell frames for water electrolyzers and could also be applied to cell frames for other electrochemical cells, such as, but not limited to, fuel cells.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A method of manufacturing a cell frame suitable for use in an electrochemical cell, said method comprising the steps of:
(a) providing a first frame portion, said first frame portion comprising an inner surface, an outer surface, a top surface, a bottom surface, and an axial port;
(b) providing a second frame portion, said second frame portion comprising an inner surface, an outer surface, a top surface, a bottom surface, and an axial port;
(c) wherein at least one of said first frame portion and said second frame portion includes a radial groove extending from its inner surface to its axial port;
(d) then, with their respective axial ports aligned, joining said first and second frame portions to one another so as to jointly define a radial passageway therebetween using said radial groove.

2. The method as claimed in claim 1 wherein said first and second frame portions are annular and have substantially corresponding overall dimensions.

3. The method as claimed in claim 1 wherein at least one of said first frame portion and said second frame portion includes a plurality of radial grooves extending from its inner surface to its axial port.

4. The method as claimed in claim 1 wherein each of said first frame portion and said second frame portion includes a plurality of radial grooves extending from its inner surface to its axial port.

5. The method as claimed in claim 4 wherein the radial grooves of said first frame portion and the radial grooves of said second frame portion are adapted for alignment with one another.

6. The method as claimed in claim 1 wherein each of said first frame portion and said second frame portion comprises a material selected from the group consisting of polymers, metals, and ceramics.

7. The method as claimed in claim 6 wherein said first frame portion and said second frame portion are made of the same material.

8. The method as claimed in claim 6 wherein said first frame portion and said second frame portion are made of different materials.

9. The method as claimed in claim 6 wherein at least one of said first frame portion and said second frame portion comprises a material selected from the group consisting of polysulfone, polyethersulfone, polyphenylene, polyphenylene sulfide, polyphenylene oxide, and polybenzimidazole.

10. The method as claimed in claim 9 wherein at least one of said first frame portion and said second frame portion is made of polysulfone.

11. The method as claimed in claim 6 wherein at least one of said first frame portion and said second frame portion comprises a polymer and a promoter to enhance bonding.

12. The method as claimed in claim 6 wherein at least one of said first frame portion and said second frame portion comprises a metal selected from the group consisting of titanium, zirconium, and niobium.

13. The method as claimed in claim 1 wherein said joining step is performed using a technique selected from the group consisting of laser welding, ultrasonic, ultra-violet, infra-red, microwave or radiofrequency radiation, thermal/pressure bonding, solvent cementing, and adhesive bonding.

14. The method as claimed in claim 1 wherein said radial groove is made by molding.

15. The method as claimed in claim 1 wherein said radial groove is made by machining.

16. The method as claimed in claim 1 wherein said first frame portion and said second frame portion have a collective thickness of no more than about 0.060 inch.

17. The method as claimed in claim 1 wherein said cell frame is suitable for use in a PEM water electrolyzer.

18. A cell frame prepared by the method of claim 1.

19. A method of manufacturing a cell frame suitable for use in an electrochemical cell, said method comprising the steps of:
(a) providing a first frame portion, said first frame portion comprising an inner surface, an outer surface, a top surface, a bottom surface, and an axial port;
(b) providing a second frame portion, said second frame portion comprising an inner surface, an outer surface, a top surface, a bottom surface, and an axial port;
(c) providing a third frame portion, said third frame portion being positioned between said first frame portion and said second frame portion, said third frame portion comprising at least one of a radial slot and a radial passageway;
(d) then, with the axial ports of said first and second frame portions aligned, joining together said first, second and third frame portions.

20. The method as claimed in claim 19 wherein said first, second and third frame portions are annular and have substantially corresponding overall dimensions.

21. The method as claimed in claim 19 wherein said second frame portion has a recess and wherein said third frame portion is mounted within said recess.

22. The method as claimed in claim 19 wherein said third frame portion comprises a plurality of radial slots.

23. The method as claimed in claim 19 wherein said third frame portion comprises a plurality of radial passageways.

24. A cell frame prepared by the method of claim 19.

25. A method of manufacturing a cell frame suitable for use in an electrochemical cell, said method comprising the steps of:
(a) providing a first frame portion, said first frame portion comprising an inner surface, an outer surface, a top surface, a bottom surface, and an axial port;
(b) providing a second frame portion, said second frame portion comprising an inner surface, an outer surface, a top surface, a bottom surface, and an axial port;
(c) providing a third frame portion, said third frame portion being positioned between said first frame portion and said second frame portion, said third frame portion comprising a porous member;
(d) then, with the axial ports of said first and second frame portions aligned, joining together said first, second and third frame portions.

26. A cell frame prepared by the method of claim 25.
